(19) United States
(12) Patent Application Publication
(10) Pub. No.: US 2010/0082990 A1
(43) Pub. Date: Apr. 1, 2010

(54) ESTABLISHMENT OF A RELATIONSHIP BETWEEN WIRELESS DEVICES

(75) Inventor: Alexandre Grigorovitch, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/240,752

(22) Filed: Sep. 29, 2008

(51) Int. Cl. H04L 9/00

(52) U.S. Cl. 713/176

(57) ABSTRACT

Embodiments related to the establishment of a relationship between wireless devices are disclosed. In one disclosed embodiment, a wireless device includes an image capture device, a wireless transmitter and receiver, a logic subsystem, and memory comprising instructions executable by the logic subsystem to capture a first image via the image capture device, identify authentication features of the first image, and receive authentication data from a remote media device via the wireless receiver that comprises authentication features of a second image. The instruction further cause the logic subsystem to compare the authentication features of the second image to the authentication features of the first image to establish a trusted relationship with the remote media device if the authentication features of the second image exhibit a pre-determined relationship to the authentication features of the first image.

### BACKGROUND

Many computing devices such as personal computers, mobile phones, personal digital assistants, and portable audio/video players, enable their users to access data wirelessly from remote sources. As one example, two or more computing devices may collectively form a personal area network to share data. Users of these computing devices may wish to limit access to the data shared via the personal area network to only specified computing devices.

### SUMMARY

Accordingly, various embodiments related to the establishment of a relationship between wireless devices is disclosed. For example, in one disclosed embodiment, a media device is described which establishes a trusted relationship with one or more remote media devices by comparing an image captured at the media device with an image received from a remote media device. Upon a satisfactory comparison of the image captured at the media device with the image received from the remote media device, a trusted relationship may be established. The trusted relationship, once established at the media device, may enable the user to transmit protected data to the remote media device or interact with data that is received from the remote media device.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically depicts an embodiment of an example media device.

FIG. 2 illustrates a non-limiting example of an interaction between embodiments of a first media device and a second media device.

FIGS. 3-5 illustrate process flows depicting embodiments of methods of establishing a trusted relationship between media devices.

### DETAILED DESCRIPTION

As will be described herein, two or more media devices may be communicatively coupled with each other through a process referred as device pairing. Device pairing may be performed in order to establish a personal area network between the two or more media devices to enable the sharing of data. Where shared data includes protected data, the device pairing process may further involve the establishment of a trusted relationship between the two or more media devices before the protected data is shared.

A trusted relationship may be established by sharing authentication data among two or more media devices. In some embodiments, the two or more media devices may share an image of a common object. As a non-limiting example, a first user may operate a first media device to capture a first image of an object. A second user may operate a second media device to capture a second image of the same object. The first and second images may be exchanged and compared to determine whether a pre-determined relationship is exhibited between the first and second images. For example, a trusted relationship may be established at the first media device with the second media device if the second image exhibits the pre-determined relationship to the first image. The process may be repeated at the second media device where a bi-directional trusted relationship is to be established.

In some embodiments, the media devices may exchange authentication data that indicates actions performed by users of the media devices. As one example, these actions may include motion of the media device, where users move their respective media devices to perform a particular gesture. The movement of each media device may be identified by authentication features (e.g. translation or blur) from one or more images captured at the media device. As another example, the users may utilize a touch-sensitive region of their respective media devices to record gestures that may be exchanged and compared to establish the trusted relationship.

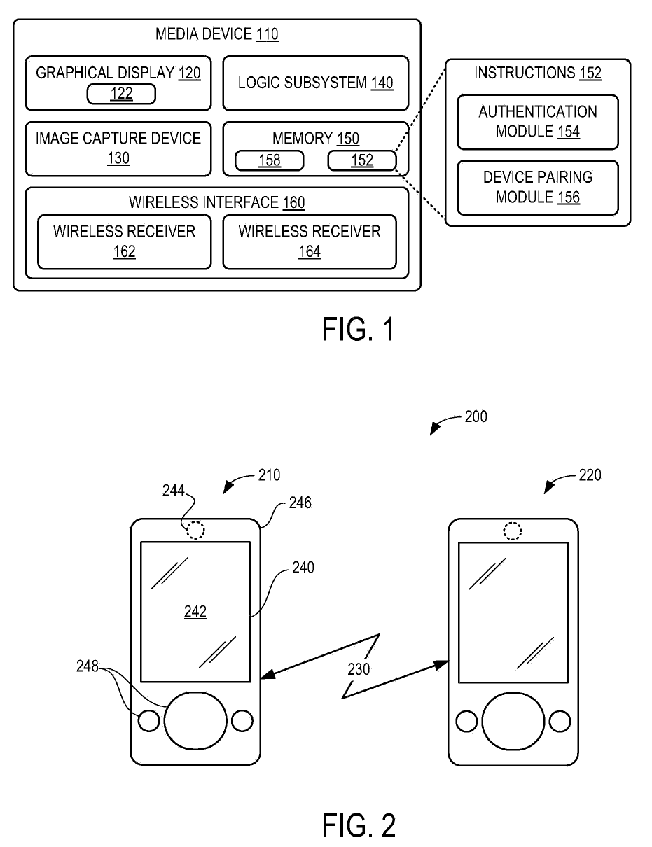

FIG. 1 schematically depicts a non-limiting example embodiment of a media device 110. Media device 110 may include one or more of the following components: a graphical display 120, an image capture device 130, a logic subsystem 140, memory 150, and a wireless interface 160. It should be appreciated that media device 110 may include other suitable components beyond those specifically described herein.

Graphical display 120 may include any suitable output device for presenting visual media content. Non-limiting examples of graphical display 120 include liquid crystal displays (LCDs), organic light emitting displays (OLEDs), plasma displays, cathode ray tube (CRT) displays, electronic paper displays, light emitting diode (LED) displays, rear projection displays, and front projection displays, among others, and combinations thereof Graphical display 120 may optionally include a touch-sensitive region 122 for receiving user input. As such, graphical display 120 may be configured to provide both input and output functionality in some embodiments. In other embodiments, graphical display 120 may be omitted from media device 110.

Image capture device 130 may include any suitable number and configuration of optical elements for capturing images. In some embodiments, image capture device 130 may include one or more of a still camera and a video camera. It should be appreciated that, image capture device 130 may capture images on an individual image basis (e.g. when operated as a still camera) or in sequential manner (e.g. when operated as a video camera).

Logic subsystem 140 may include one or more physical devices configured to execute one or more instructions. For example, the logic subsystem may be configured to execute one or more instructions that are part of one or more programs, routines, objects, components, data structures, or other logical constructs. Such instructions may be implemented to perform a task, implement a data type, change the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory 150 may include one or more physical devices configured to hold data and/or instructions 152 that, when executed by the logic subsystem, cause the logic subsystem to implement the herein described methods and processes. Memory 150 may include removable media and/or built-in devices. Memory 150 may include optical memory devices, semiconductor memory devices, and/or magnetic memory devices, among others. Memory 150 may include portions with one or more of the following characteristics: volatile, nonvolatile, dynamic, static, read/write, read-only, random access, sequential access, location addressable, file addressable, and content addressable. In some embodiments, logic subsystem 140 and memory 150 may be integrated into one or more common devices and/or computing systems.

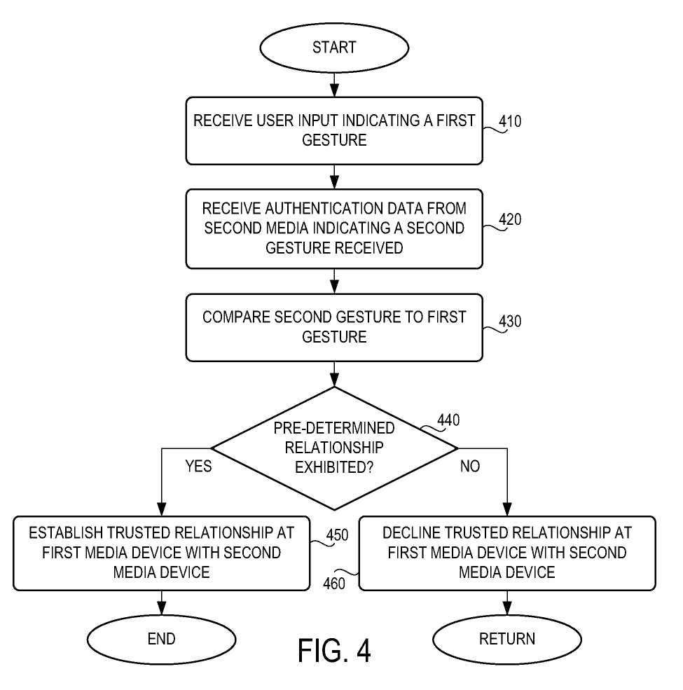

As will be described in greater detail in the context of the process flow of FIGS. 3-5, instructions 152 may include one or more modules that, when executed by the logic subsystem, cause the logic subsystem to perform one or more of the various operations described herein. For example, in some embodiments, instructions 152 may include an authentication module 154 for establishing trusted relationships with remote media devices and a device pairing module 156 for establishing personal area networks with the remote media devices. In some embodiments, memory 150 may further include a data store 158 for storing data, including media content such as audio content, visual content, and communication content, among other suitable data. For example, data store 158 may store images captured by image capture device 130.

Wireless interface 160 may include one or more of a wireless receiver 162 for receiving wireless data transmissions from remote sources and a wireless transmitter 164 for transmitting wireless data transmissions to remote sources. For example, wireless receiver 162 may be configured to receive data broadcast by remote media devices and wireless transmitter 164 may be configured to broadcast data to remote media devices. In some embodiments, wireless receiver 162 and wireless transmitter 164 may be combined as a wireless transceiver.

It should be appreciated that wireless interface 160 may be configured to transfer data wirelessly using any suitable protocol, including Bluetooth, Wi-Fi, Short Message Service (SMS), and cellular telephony, among others. Furthermore, it should be appreciated that wireless interface 160 may communicate with remote sources by the transfer of electromagnetic radiation within any suitable spectral range, including microwaves, radio frequency, visible light (e.g. via a laser), and infrared light, among others.

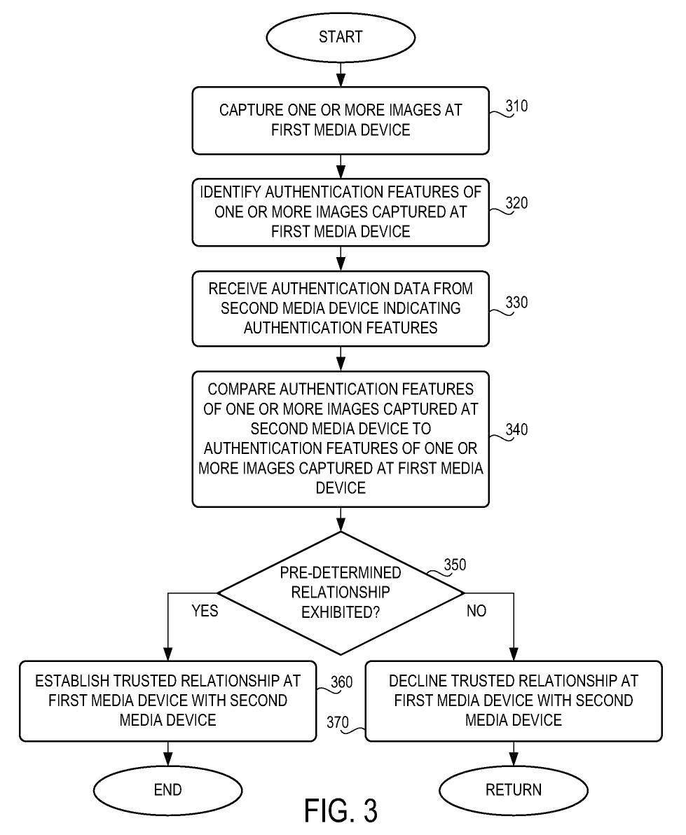

FIG. 2 illustrates a non-limiting example of an interaction 200 between embodiments of a first media device 210 and a second media device 220. In this particular example, media device 210 and media device 220 each correspond to previously described media device 100 of FIG. 1. FIG. 2 illustrates first media device 210 interacting with second media device 220 via wireless communication 230. As such, FIG. 2 depicts an example of device pairing between two or more media devices which may be used to collectively establish a personal area network between these media devices.

Wireless communication 230 may schematically represent the sharing of data. In some embodiments, data shared between two or more media devices may include one or more of authentication data, protected data, and provisional data. Authentication data may include data that is received by a media device from a remote media device that may be used by the media device to establish a personal area network or to establish a trusted relationship with the remote media device. Protected data may include data that the media device does not share with other media devices until a trusted relationship is established. As such, transmission of protected data may not be performed in some embodiments until a trusted relationship is established with a remote source. Provisional data may include data that is received by a media device from a remote source, such as a remote media device, that is not useful to the media device to establish a personal area network or to establish a trusted relationship with the remote media device. As such, provisional data that is received by a media device from remote sources, such as a remote media device, may be quarantined at the media device until a trusted relationship is established at the media device with the remote media device.

First media device 210 includes a graphical display 240 as previously described with reference to graphical display 120 of FIG. 1. In some embodiments, graphical display 240 may include a touch-sensitive region 242 as previously described with reference to touch-sensitive region 122 of FIG. 1. First media device 210 may include an image capture device 244 as previously described with reference to image capture device 130 of FIG. 1. First media device 210 may further include a device body 246 and may optionally include one or more buttons 248. Buttons 248 may be used to receive user input in addition to or as an alternative to touch-sensitive region 242 of first media device 210.

Second media device 220 may include one or more similar components as first media device 210. As such, second media device 220 will not be described in any further detail.

FIGS. 3-5 illustrate process flows depicting example methods of pairing media devices (including media devices 110, 210, and 220) via wireless communication. It should be appreciated that these process flows may represent instructions that may be held in memory 150, which may be executed by logic subsystem 140. As a non-limiting example, the process flows of FIGS. 3-5 may be applied to interaction 200 of FIG. 2 to enable device pairing of first media device 210 and second media device 220 via wireless communication 230 by establishing a trusted relationship. It should be appreciated that the process flows of FIGS. 3-5 will be described in the context of first media device 210, but may be similarly applied to second media device 220. As such, second media device 220 may be referred to as a remote media device in this particular context and first media device 210 may be simply referred to as the media device.

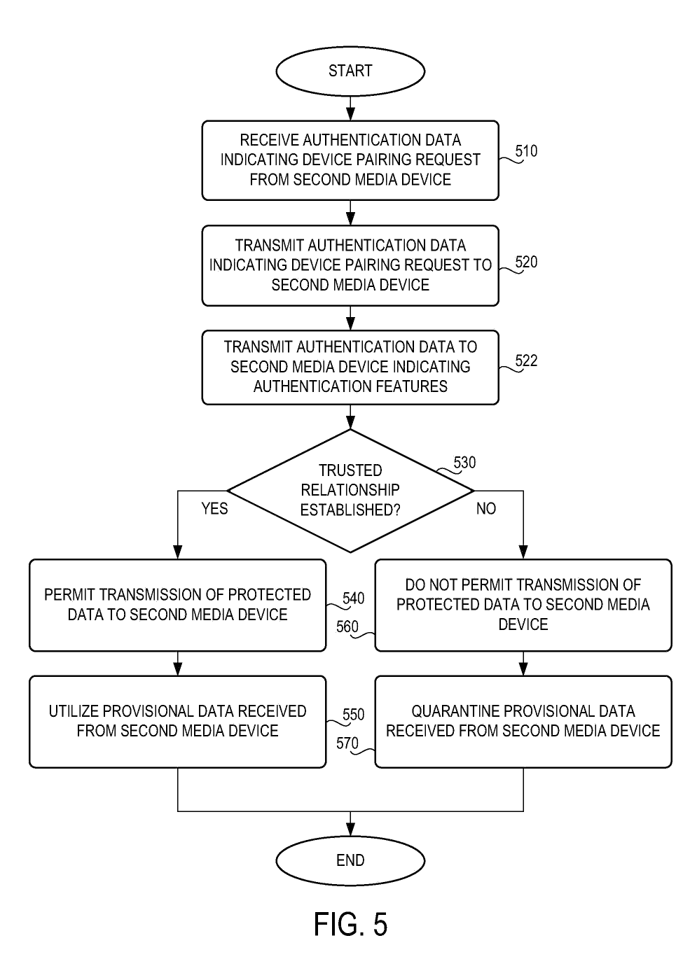

Referring now to the process flow of FIG. 3, an embodiment of a first method for establishing a trusted relationship at a first media device with a second media device is described. At 310, one or more images may be captured at the first media device via the image capture device. For example, a user of first media device 210 may operate image capture device 244 by pressing buttons 242 or touch-sensitive region 242. In some embodiments, the first media device may prompt its user to operate the image capture device to capture the one or more images in response to receiving a device pairing request as will be described in greater detail with reference to the process flow of FIG. 5.

At 320, authentication features of the one or more images captured at the first media device may be identified. For example, the authentication module may cause the logic subsystem of the first media device to identify authentication features of the one or more images captured at the first media device using any suitable approach, including one or more of interest point detection, edge detection, corner detection, blob detection, ridge detection, feature detection, object recognition, texture analysis, and blur detection, among others.

In one embodiment, authentication module 154 may cause the logic subsystem to identify a blur kernel of the one or more images captured at the first media device using blur detection. The blur kernel may provide an indication of a path of motion that the first media device traveled as the one or more images were captured. In this way, the first media device may identify a motion path of the first media device; and where the authentication features of the one or more images captured at the first media device indicates the motion path of the first media device. It should be appreciated that in other embodiments, the authentication features may indicate static characteristics of the one or more images even if the first media device is not moved when the one or more images are captured.

At 330, authentication data may be received from the second media device via wireless communication, where the authentication data indicates authentication features of one or more images captured at the second media device. As a non-limiting example, second media device 220 may be operated by a second user to capture one or more images, where the authentication features of the one or more images captured at the second media device may be identified at the second media device before being transmitted (e.g. broadcast) and subsequently received at the first media device.

In some embodiments, the authentication data that is received at the first media device from the second media device may include the one or more images captured at the second media device, whereby the first media device may apply a similar process utilized at 320 to identify the authentication features of the one or more images captured at the second media device. As such, it should be appreciated that identification of these images may be performed at each media device or at only one of the two or more media devices.

At 340, the authentication features of the one or more images captured at the second media device and received at 330 may be compared to the authentication features of the one or more images captured at the first media device and identified at 320. In some embodiments, the authentication module of the first media device may cause the logic subsystem to perform this comparison. For example, the logic subsystem may compare authentication features by identifying a deviation of the motion path of the second media device from the motion path of the first media device.

At 350, it may be judged whether the authentication features of the one or more images captured at the second media device exhibit a pre-determined relationship to the authentication features of the one or more images captured at the first media device. In some embodiments, the pre-determined relationship may include an error or deviation between the authentication features of the one or more images captured at the first media device and the authentication features of the one or more images captured at the second media device based on the comparison performed at 340. For example, the authentication module may cause the logic subsystem to judge that the pre-determined relationship is exhibited when the error or the deviation is less than a threshold and may judge that the pre-determined relationship is not exhibited when the error or the deviation is greater than the threshold.

In some embodiments, a user of the first media device may select, set, or adjust the predetermined relationship applied at 350 in accordance with a security preference of the user. As such, it should be appreciated that the first media device may utilize a pre-determined relationship that is different from a pre-determined relationship utilized by the second media device to establish a trusted relationship.

At 360, a trusted relationship may be established at the first media device with the second media device if authentication features of the one or more images captured at the second media device exhibit the pre-determined relationship to the authentication features of the one or more images captured at the first media device. In some embodiments, the authentication module of the first media device may notify the device pairing module that the trusted relationship has been established. In response to receiving a notification from the authentication module that the trusted relationship has been established, the device pairing module may establish the personal area network with the second media device was will be described in greater detail with reference to the process flow of FIG. 5. From 360, the process flow of FIG. 3 may end and the process flow of FIG. 5 may be optionally performed.

Alternatively, if the predetermined relationship is not exhibited between the one or more images captured at the first media device and the one or more images captured at the second media device, the process flow may instead proceed to 370. At 370, the trusted relationship may be denied at the first media device with the second media device if authentication features of the one or more images captured at the second media device do not exhibit the predetermined relationship to the authentication features of the one or more images captured at the first media device.

In some embodiments, the authentication module of the first media device does not notify the device pairing module that the trusted relationship has been established. In some embodiments, the authentication module of the first media device may notify the device pairing module that the trusted relationship has been declined, which may cause the device pairing module to decline to establish a personal area network with the second media device. As will be described by the process flow of FIG. 5, protected data may not be transmitted to the second media device by the first media device and provisional data that is received from the second media device by the first media device may be quarantined if the trusted relationship has not been established or if the trusted relationship has been declined.

From 370, the process flow may return. In some embodiments, the process flow may return to 310 where one or more images may be again captured at the first media device. For example, the authentication module may cause the first media device to prompt its user to capture one or more new images. In some embodiments, the process flow may return to 330 where new authentication data may be received at the first media device from the second media device, where the new authentication data indicates authentication features of new images captured at the second media device. In this way, one or more attempts may be made by media device users to establish a trusted relationship by exchanging images or authentication features of these images.

Referring now to the process flow of FIG. 4, a second embodiment of a method for establishing a trusted relationship at a first media device with a second media device is described. At 410, user input may be received via a touch-sensitive region of a first media device, such as touch-sensitive region 242 of graphical display 240, where the user input received via the touch-sensitive region of the first media device indicates a first gesture. For example, a user of the first media device may perform the first gesture by moving his or her finger across the touch-sensitive region. As a non-limiting example, the first gesture may depict a text character, a numerical character, a shape, or any suitable gesture.

At 420, authentication data may be received at the first media device from the second media device via the wireless receiver, where the authentication data indicates a second gesture received at the second media device. For example, a user of a second media device may attempt to replicate the first gesture by submitting a user input via a touch-sensitive region of the second media device, where the user input received via the touch-sensitive region of the second media device indicates the second gesture.

At 430, the second gesture may be compared to the first gesture. In some embodiments, an authentication module of the first media device may compare the second gesture indicated by the authentication data received from the second media device to the first gesture indicated by the user input received at the touch-sensitive region of the first media device.

At 440, it may be judged whether a pre-determined relationship between the first gesture and the second gesture is exhibited based on the comparison performed at 430. As previously described with reference to operation 350 of FIG. 3, the pre-determined relationship may include an error or a deviation between the first gesture and the second gesture. In some embodiments, a user of the first media device may select, set, or adjust the predetermined relationship in accordance with a security preference of the user. As such, it should be appreciated that the first media device may utilize a pre-determined relationship that is different from a pre-determined relationship utilized by the second media device to establish a trusted relationship.

At 450, a trusted relationship may be established at the first media device with the second media device if the second gesture exhibits the pre-determined relationship to the first gesture. In some embodiments, the authentication module of the first media device may notify the device pairing module that the trusted relationship has been established. The device pairing module, in response to receiving notification from the authentication module that the trusted relationship has been established with the second media device, may cause the logic subsystem to establish a personal area network with the second media device.

Alternatively, if the predetermined relationship is not exhibited between the first gesture and the second gesture, the process flow may instead proceed to 460. At 460, the trusted relationship may be declined at the first media device with the second media device if the second gesture does not exhibit the pre-determined relationship to the first gesture.

In some embodiments, the authentication module of the first media device does not notify the device pairing module if the trusted relationship has not been established. In some embodiments, the authentication module may notify the device pairing module that the trusted relationship has been declined, which may cause the device pairing module to decline the personal area network with the second media device. As will be described by the process flow of FIG. 5, protected data may not be transmitted to the second media device by the first media device and provisional data that is received from the second media device by the first media device may be quarantined if the trusted relationship has not been established with the second media device or if the trusted relationship has been declined at the first media device.

From 460, the process flow may return. In some embodiments, the process flow may return to 410 where one or more new user inputs may be received via the touch-sensitive region of the first media device that indicate one or more new gestures. For example, the authentication module may cause the first media device to prompt its user to submit a new gesture. In some embodiments, the process flow may return to 420 where new authentication data may be received at the first media device from the second media device, where the new authentication data indicates a new gesture received at the second media device. In this way, one or more attempts may be made by media device users to establish a trusted relationship by exchanging gestures that were performed using touch-sensitive regions of their respective media devices.

Referring now to the process flow of FIG. 5, an embodiment of a method of establishing a personal area network between a first media device and a second media device is described. At 510, authentication data may be received from the second media device at the first media device via the wireless receiver, where the authentication data received at 510 indicates a device pairing request. In some embodiments, the second media device may transmit the authentication data indicating the device pairing request responsive to detection of the first media device.

At 520, the first media device may transmit authentication data to the second media device via the wireless transmitter, where the authentication data transmitted at 520 indicates a device pairing request. In some embodiments, the first media device may transmit the authentication data indicating the device pairing request responsive to detection of the second media device.

At 522, the first media device may transmit authentication data from the first media device to the second media device via wireless communication. In some embodiments, the authentication data transmitted to the second media device may indicate the authentication features of the one or more images captured at the first media device. In some embodiments, the authentication data transmitted to the second media device may indicate the first gesture received via the touch-sensitive region of the graphical display of the first media device.

The authentication data transmitted to the second media device at 522 may cause the second media device to establish a trusted relationship with the first media device if the authentication features transmitted to the second media device exhibit a pre-determined relationship to the authentication features of the one or more images captured at the second media device. Similarly, the authentication data transmitted to the second media device at 522 may cause the second media device to establish a trusted relationship with the first media device if the first gesture indicated by the authentication data exhibits a pre-determined relationship to the authentication features of the second gesture received the second media device. As such, it should be appreciated that the pre-determined relationship used by the first media device may be a first pre-determined relationship and the second media device may used a second pre-determined relationship that is the same as or different than the first pre-determined relationship.

At 530, it may be judged whether a trusted relationship has been established at the first media device with the second media device. The answer at 530 may be judged responsive to performance of at least one of operation 360 of FIG.3 and operation 450 of FIG. 4. For example, the device pairing module of the first media device may judge whether notification has been received from the authentication module indicating that the trusted relationship has been established with the second media device. If the answer at 530 is judged yes, the process flow may proceed to one or more of operations 540 and 550.

At 540, transmission of protected data from the first media device to the second media device via the wireless transmitter may be permitted by the logic subsystem. In some embodiments, the device pairing module may cause the logic subsystem to permit protected data residing at data store 158 to be transmitted to the second media device only if the trusted relationship has been established at the first media device with the second media device in accordance with at least one of the process flows of FIGS. 3 and 4. For example, the first media device may establish a personal area network between the first media device and the second media device only if the trusted relationship has been established at the first media device with the second media device. The protected data may be transmitted protected data from the first media device to the second media device through the personal area network via wireless communication only if the trusted relationship has been established at the first media device with the second media device.

At 550, provisional data received from the second media device via the wireless receiver may be utilized at the first media device. For example, where the provisional data includes media content, the first media device may enable its user to interact with the media content. In some embodiments, the device pairing module of the first media device does not permit the user of the first media device to interact with the provisional data until a trusted relationship has been established at the first media device with the second media device in accordance with at least one of the process flows of FIGS. 3 and 4.

Alternatively, if the answer at 530 is judged no, the process flow may proceed to one or more of operations 560 and 570. At 560, transmission of protected data from the first media device to the second media device via the wireless transmitter is not permitted. For example, the device pairing module may cause the logic subsystem to decline transmission of protected information to remote sources that the first media device has not established a trusted relationship.

At 570, provisional data received at the first media device from the second media device via the wireless receiver is quarantined at the first media device if the trusted relationship has been declined. For example, the device pairing module may cause the logic subsystem to decline user interaction with the provisional data received at the first media device from remote sources until the first media device has established a trusted relationship with the remote sources.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and non-obvious combinations and subcombinations of the various processes, systems and configurations, and other features, functions, acts, and/or properties disclosed herein, as well as any and all equivalents thereof.

1. A method of pairing media devices via wireless communication, comprising:
capturing one or more images at a first media device via an image capture device;
identifying one or more authentication features of the one or more images captured at the first media device;
receiving authentication data from a second media device at the first media device via wireless communication, the authentication data comprising one or more authentication features of one or more images captured at the second media device; and
establishing a trusted relationship at the first media device with the second media device if the one or more authentication features of the one or more images captured at the second media device exhibit a pre-determined relationship to the one or more authentication features of the one or more images captured at the first media device.

2. The method of claim 1, further comprising, transmitting authentication data from the first media device to the second media device via wireless communication, the authentication data transmitted to the second media device indicating the one or more authentication features of the one or more images captured at the first media device, where the authentication data transmitted to the second media device causes the second media device to:
establish a trusted relationship with the first media device if the one or more authentication features transmitted to the second media device exhibit a pre-determined relationship to the one or more authentication features of the one or more images captured at the second media device; and
decline the trusted relationship with the first media device if the one or more authentication features transmitted to the second media device do not exhibit the pre-determined relationship to the one or more authentication features of the one or more images captured at the second media device.

3. The method of claim 1, further comprising, establishing a personal area network between the first media device and the second media device only if the trusted relationship has been established at the first media device with the second media device.

4. The method of claim 3, further comprising, transmitting protected data from the first media device to the second media device through the personal area network via wireless communication only if the trusted relationship has been established at the first media device with the second media device.

5. The method of claim 1, further comprising, receiving provisional data from the second media device at the first media device via wireless communication; and quarantining the provisional data at the first media device if the trusted relationship has been declined at the first media device with the second media device.

6. The method of claim 1, where identifying the one or more authentication features of the one or more images captured at the first media device includes identifying a blur kernel from the one or more images captured at the first media device; and
where the one or more authentication features of the one or more images captured at the first media device comprise the blur kernel.

7. The method of claim 1, where identifying the one or more authentication features of the one or more images captured at the first media device includes identifying a motion path of the first media device; and where the one or more authentication features of the one or more images captured at the first media device indicates the motion path of the first media device.

8. The method of claim 7, where the one or more authentication features received from the second media device indicates a motion path of the second media device; and
where comparing the one or more authentication features received from the second media device to the one or more authentication features of the one or more images captured at the first media device includes identifying a deviation of the motion path of the second media device from the motion path of the first media device.

9. A media device, comprising:
an image capture device;
a wireless receiver configured to receive data broadcast by remote media devices;
a logic subsystem; and
memory comprising instructions that are executable by the logic subsystem to:
capture a first image via the image capture device;
identify one or more authentication features of the first image;
receive authentication data from a remote media device via the wireless receiver, the authentication data comprising one or more authentication features of a second image;
compare the one or more authentication features of the second image to the one or more authentication features of the first image;
establish a trusted relationship with the remote media device if the one or more authentication features of the second image exhibit a pre-determined relationship to the one or more authentication features of the first image; and
decline the trusted relationship with the remote media device if the one or more authentication features of the second image do not exhibit the pre-determined relationship to the one or more authentication features of the first image.

10. The media device of claim 9, further comprising, a wireless transmitter configured to transmit data to remote media devices; and
where the memory further comprises instructions that are executable by the logic subsystem to cause the logic subsystem to:
transmit authentication data to the remote media device via the wireless transmitter, the authentication data transmitted to the remote media device indicating the authentication features of the first image.

11. The media device of claim 10, where the pre-determined relationship is a first pre-determined relationship, and where the authentication data transmitted to the remote media device causes the remote media device to:
establish a trusted relationship with the media device if the authentication features of the first image exhibits a second pre-determined relationship to the authentication features of the second image; and
decline the trusted relationship with the media device if the authentication features of the first image do not exhibit the second pre-determined relationship to the authentication features of the second image.

12. The media device of claim 9, where the first image is one of a plurality of images captured via the image capture device of the media device; and
where the authentication data received from the remote media device further indicates one or more authentication features of a plurality of images including the second image captured at the remote media device.

13. The media device of claim 9, further comprising, a wireless transmitter configured to transmit data to remote media devices; and
where the memory further comprises instructions that are executable by the logic subsystem to cause the logic subsystem to transmit protected data to the remote media device via the wireless transmitter only if the trusted relationship has been established with the remote media device.

14. The media device of claim 9, where the memory further comprises instructions that are executable by the logic subsystem to cause the logic subsystem to quarantine provisional information received from the second media device via the wireless receiver until the trusted relationship has been established at the first media device with second media device.

15. The media device of claim 9, further comprising a graphical display, and where the memory further comprises instructions that are executable by the logic subsystem to cause the logic subsystem to:
receive a device pairing request from the remote media device via the wireless receiver; and
prompt a user of the media device via the graphical display to operate the media device to capture the first image via the image capture device in response to receiving the pairing request from the remote media device.

16. A media device, comprising:
a graphical display including a touch-sensitive region for receiving user input;
a wireless receiver configured to receive data broadcast by remote media devices;
a logic subsystem; and
memory comprising instructions that are executable by the logic subsystem to cause the logic subsystem to:
receive a user input via the touch-sensitive region of the graphical display, the user input indicating a first gesture;
receive authentication data from a remote media device via the wireless receiver, the authentication data comprising data representing a second gesture received at the remote media device;
compare the second gesture to the first gesture;
establish a trusted relationship with the remote media device if the second gesture exhibits a pre-determined relationship to the first gesture; and
decline the trusted relationship with the remote media device if the second gesture does not exhibit the pre-determined relationship to the first gesture.

17. The media device of claim 16, further comprising, a wireless transmitter configured to transmit data to remote media devices; and
where the memory further comprises instructions that are executable by the logic subsystem to cause the logic subsystem to:
transmit authentication data to the remote media device via the wireless transmitter, the authentication data transmitted to the remote media device indicating the first gesture.

18. The media device of claim 17, where the pre-determined relationship is a first pre-determined relationship; and
where the authentication data transmitted to the remote media device causes the remote media device to:
establish a trusted relationship at the remote media device with the media device if the first gesture exhibits a second pre-determined relationship to the second gesture; and
decline the trusted relationship at the remote media device with the media device if the first gesture does not exhibit the second pre-determined relationship to the second gesture.

19. The media device of claim 18, where the first pre-determined relationship is different than the second pre-determined relationship.

20. The media device of claim 16, where the memory further comprises instructions that are executable by the logic subsystem to cause the logic subsystem to:
receive a device pairing request from the remote media device via the wireless receiver; and
prompt a user of the media device to submit the user input to the media device via the touch-sensitive region of the graphical display in response to receiving the device pairing request from the remote media device.
